(19) United States
(12) Patent Application Publication
(10) Pub. No.: US 2016/0245446 A1
(43) Pub. Date: Aug. 25, 2016

(54) INFRARED PIPELINE HEATER

(71) Applicants: Virgil Macaluso, (US); Catalytic Industrial Group, Inc., Independence, KS (US)

(72) Inventors: Virgil Macaluso, Independence, KS (US); Corey Lowdon, Independence, KS (US); Bruce Brooks, Independence, KS (US)

(21) Appl. No.: 15/052,212

(22) Filed: Feb. 24, 2016

Related U.S. Application Data
(60) Provisional application No. 62/120,733, filed on Feb. 25, 2015.

(51) Int. Cl. F16L 53/00

(52) U.S. Cl. CPC F16L 53/004

(57) ABSTRACT

A pipeline heater (20) for warming a fluid stream, such as a fluid being carried by a natural gas or petroleum pipeline includes a housing (22) having a plurality of IR heating elements (118) and coils (110) installed therein. Individual conduits (88, 90) direct the fluid stream into and out of the housing (22). Coils (110) direct portions of the fluid stream from the conduits (88, 90) past a plurality of IR heating elements (118).

### CROSS-REFERENCE TO RELATED APPLICATION

This application claims the benefit of U.S. Provisional Application Ser. No. 62/120,733 filed Feb. 25, 2015, which is incorporated herein by reference in its entirety.

### BACKGROUND OF THE INVENTION

1. Field of the Invention

The present invention generally pertains to a pipeline heating apparatus and methods of heating gas and liquid streams using the same. The preferred pipeline heaters employ flameless, catalytic infrared (IR) emitters positioned adjacent fluid-conveying coils in order to warm the fluids flowing therethrough.

2. Description of the Prior Art

Pipeline heaters are used to heat gas and liquids flowing through pipelines in order to prevent regulators and various sensing equipment from freezing up during pipeline operation. Traditionally, water bath indirect heaters have been used for this purpose. In water bath heaters, a vessel is filled with water or a mixture of water and ethylene glycol. A fire tube and process coil are submerged in the bath which transfers heat from the fire tube to the process stream in the coil. These types of heaters have the drawback in that the fire tubes produce significant amounts of noise and ethylene glycol presents health risks to people, pets, and property. In addition, water bath heaters tend to be less efficient because the heat transfer occurs through an intermediate medium, namely the water solution.

Because of the undesirable attributes of conventional water bath heaters, there is a need for quiet and efficient apparatus and methods for heating pipeline fluids such as natural gas and other hydrocarbon streams. Furthermore, there is a particular need for environmentally friendly pipeline heater systems that generates virtually no nitrous oxide or volatile organic compounds. U.S. Pat. No. 7,066,730, which is incorporated by reference herein in its entirety, discloses one such pipeline heater. However, the normal draft induced through the heater housing results in reduced heater efficiency. Therefore, there is a need in the art for an improved heater apparatus that better controls the natural draft through the heater so that the heater operates more efficiently.

### SUMMARY OF THE INVENTION

According to one embodiment of the present invention there is provided a pipeline heater operable to warm a fluid, i.e., either liquids, gases, or mixtures thereof. The pipeline heater generally comprises a housing including a plurality of wall sections defining an enclosed space. At least one of the wall sections comprises at least one selectively controllable air flow damper installed therein to control the flow of air into the enclosed space. At least one other of the wall sections comprises a vent opening through which air and exhaust gases flow out of the enclosed space. The heater also comprises at least two conduit sections located within the housing. One of the conduit sections is configured to conduct a fluid stream into the housing, and one other of the conduit sections is configured to conduct the fluid stream out of the housing. There is at least one coil disposed within the housing having a coil inlet and a coil outlet. The coil inlet is fluidly coupled with the conduit section configured to conduct the fluid stream into the housing. The coil outlet is fluidly coupled with the conduit section configured to conduct the fluid stream out of the housing. There are a plurality of infrared catalytic heaters located adjacent to the at least one coil and configured to warm the fluid stream flowing within the coil.

According to another embodiment of the present invention there is provided a pipeline heater operable to warm a fluid, i.e., either liquids, gases, or mixtures thereof. The pipeline heater generally comprises a housing including an upper housing portion and a lower housing portion, preferably in the form of a relatively large primary housing and a superposed, relatively small secondary housing in communication with the primary housing. At least two conduits or headers are located within the upper housing portion. One of the conduit is configured to conduct a fluid stream into the housing, and one other of the conduit is configured to conduct the fluid stream out of the housing. At least one coil is disposed within the housing having a coil inlet and a coil outlet. The coil inlet is fluidly coupled with the conduit configured to conduct the fluid stream into the housing, and the coil outlet is fluidly coupled with the conduit configured to conduct the fluid stream out of the housing. A plurality of infrared catalytic heaters are located adjacent to the at least one coil and configured to warm the fluid stream flowing within the coil.

According to another embodiment of the present invention there is provided a method of warming a fluid stream comprising the steps of providing and operating a pipeline heater as described herein. Fluid is directed into the pipeline heater via one of the conduit sections. The fluid is then caused to enter the at least one coil of the pipeline heater. The plurality of heaters are operated so as to direct heat energy to the at least one coil for transfer to the fluid to form a warmed fluid. The warmed fluid is removed from the pipeline heater via one other of the conduit sections.

### BRIEF DESCRIPTION OF THE DRAWINGS

FIG. 1 is a top perspective view, with certain parts broken away, of an infrared pipeline heater in accordance with the invention, illustrated with the forward doors thereof in an opened condition;

FIG. 2 is a side perspective view of the pipeline heater illustrated in FIG. 1;

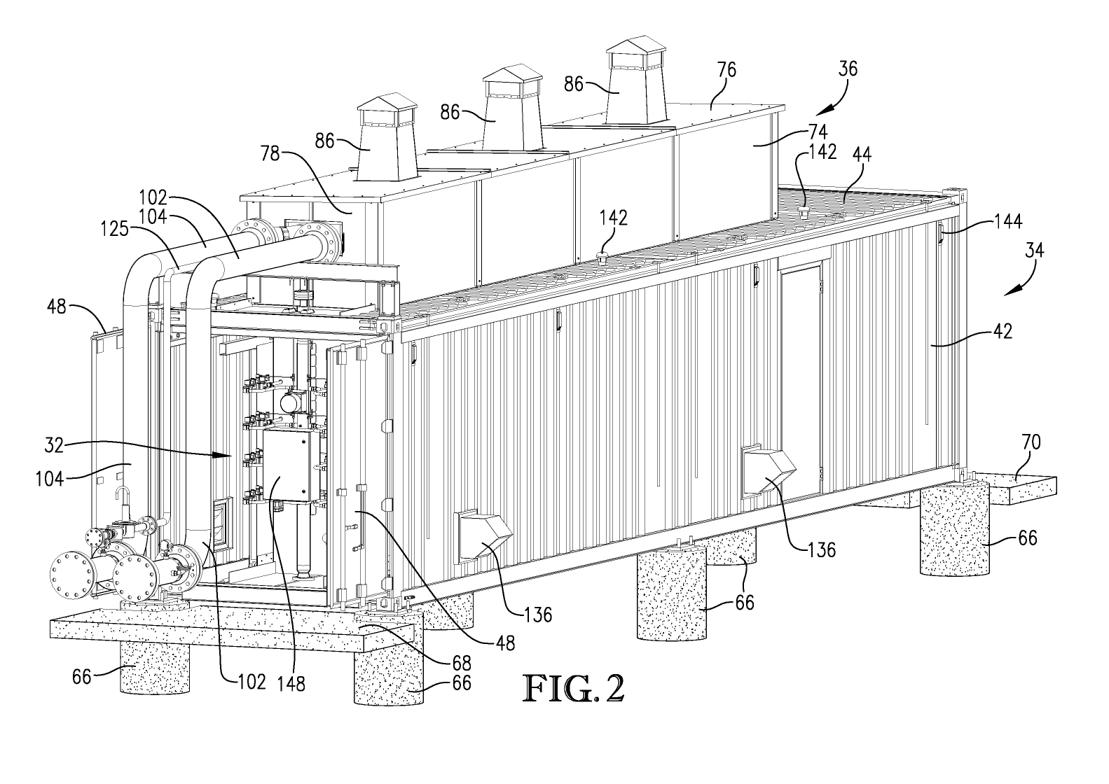

FIG. 3 is a top perspective view of the pipeline heater illustrated in FIGS. 1-2, but depicting the rearward end of the heater and the sidewall thereof opposite that seen in FIG. 1;

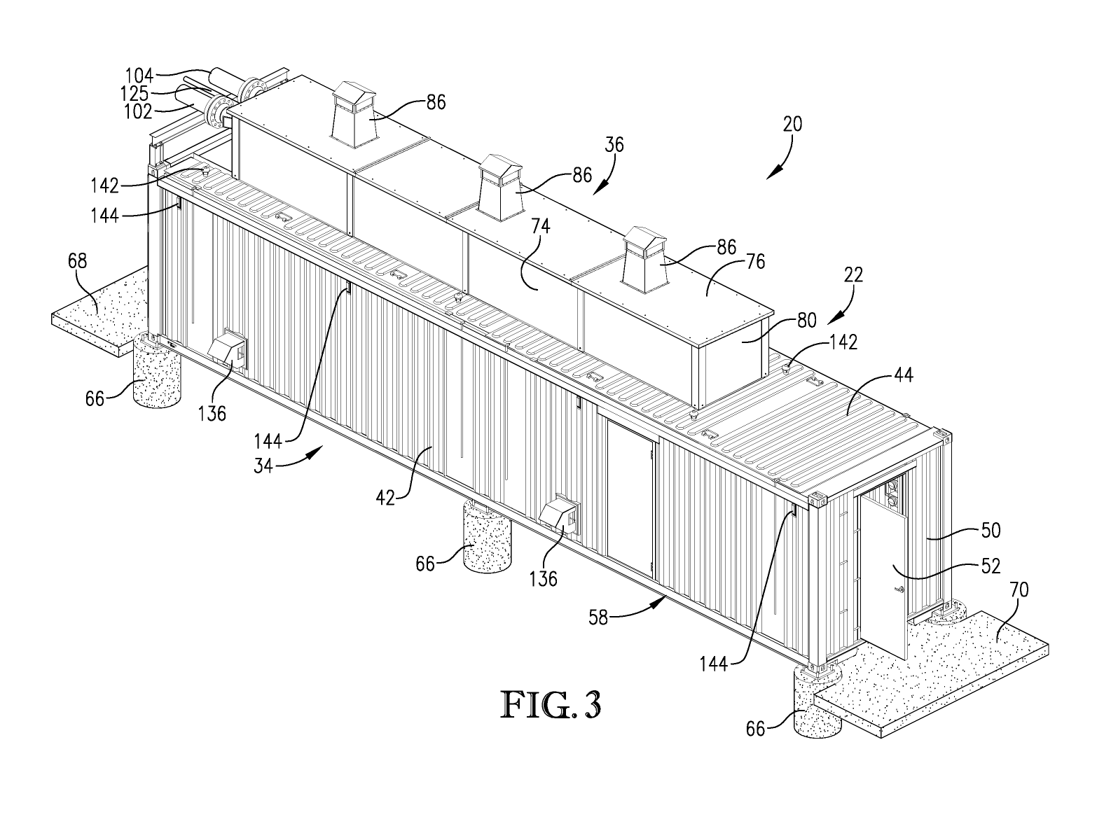

FIG. 4 is a side perspective view of the pipeline heater of FIG. 1, with the sidewall structure removed to depict the inner heat insulating assembly of the heater;

FIG. 5 is an enlarged, fragmentary, perspective view illustrating the forward end of the heater of FIG. 1, with parts broken away to illustrate the internal construction of the heater;

FIG. 6 is a fragmentary, perspective view similar to that of FIG. 4, but with the heat insulating assembly removed to illustrate portions of the infrared heating assembly of the pipeline heater;

FIG. 7 is another side perspective view similar to that of FIG. 6, but with the infrared heating assembly removed to illustrate the fluid-conveying coil assembly of the pipeline heater;

FIG. 8 is a bottom perspective view of the fluid-conveying coil assembly of the pipeline heater;

FIG. 9 is a top view with parts removed to illustrate the relationship of the fluid-conveying coil assembly, the infrared heating assembly, the insulating assembly, and the sidewalls of the housing of the pipeline heater; and

FIG. 10 is a vertical sectional view of the pipeline heater, illustrating the pattern of induced cooling air flow developed in the heater by the air cooling assembly thereof

### DETAILED DESCRIPTION OF THE PREFERRED EMBODIMENT

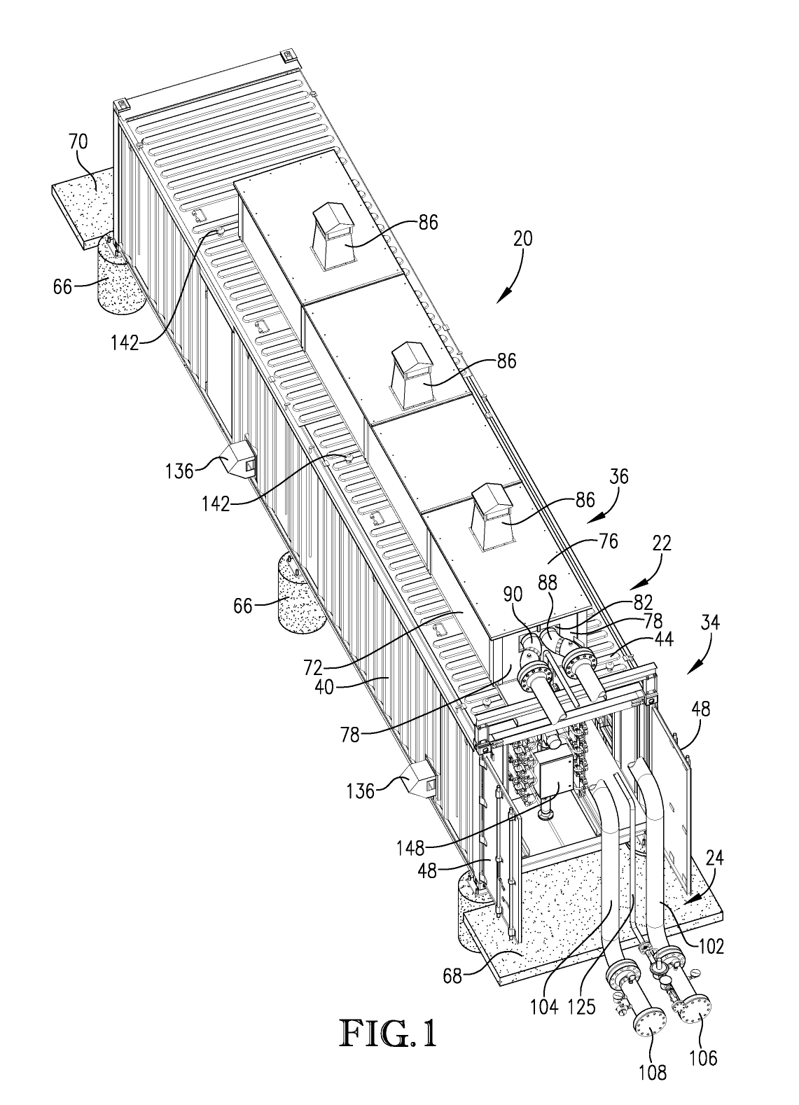

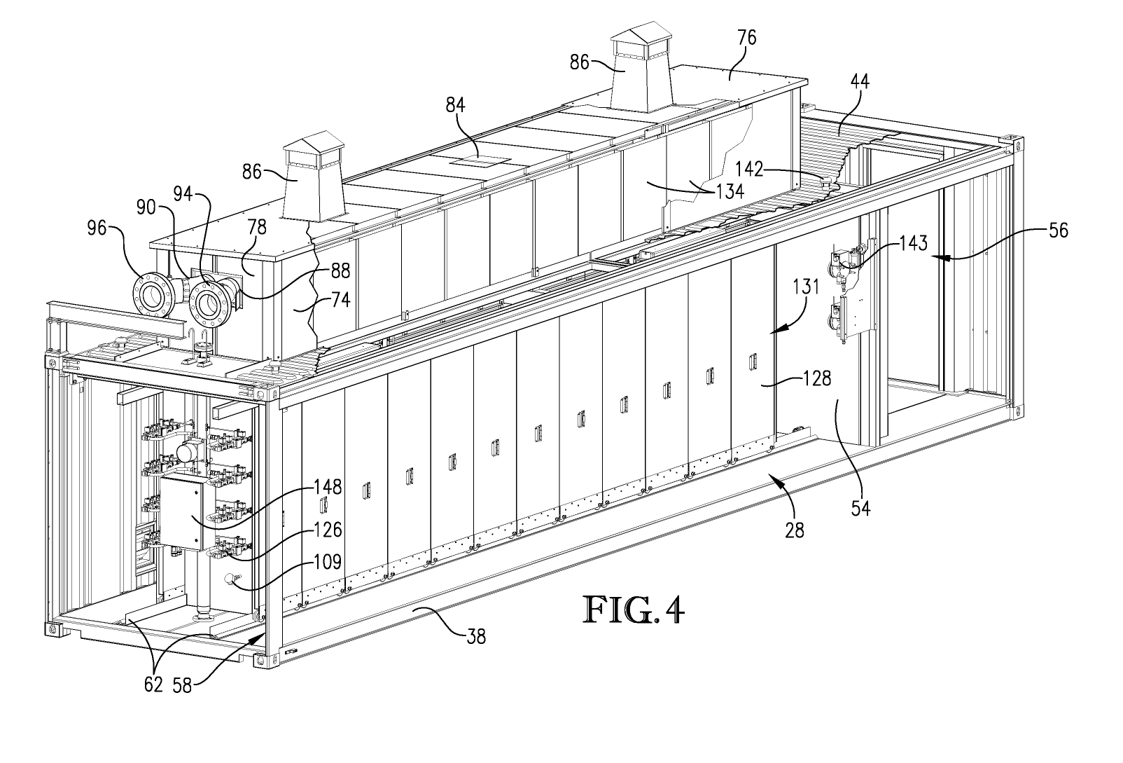

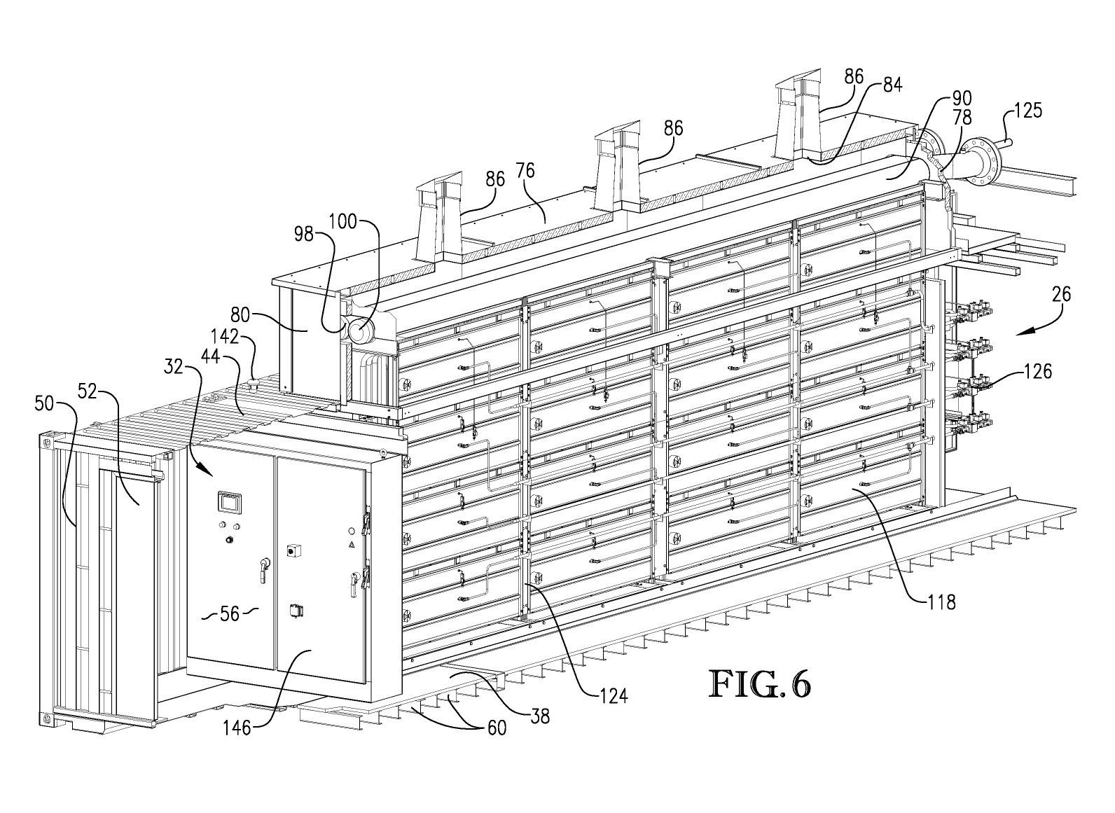

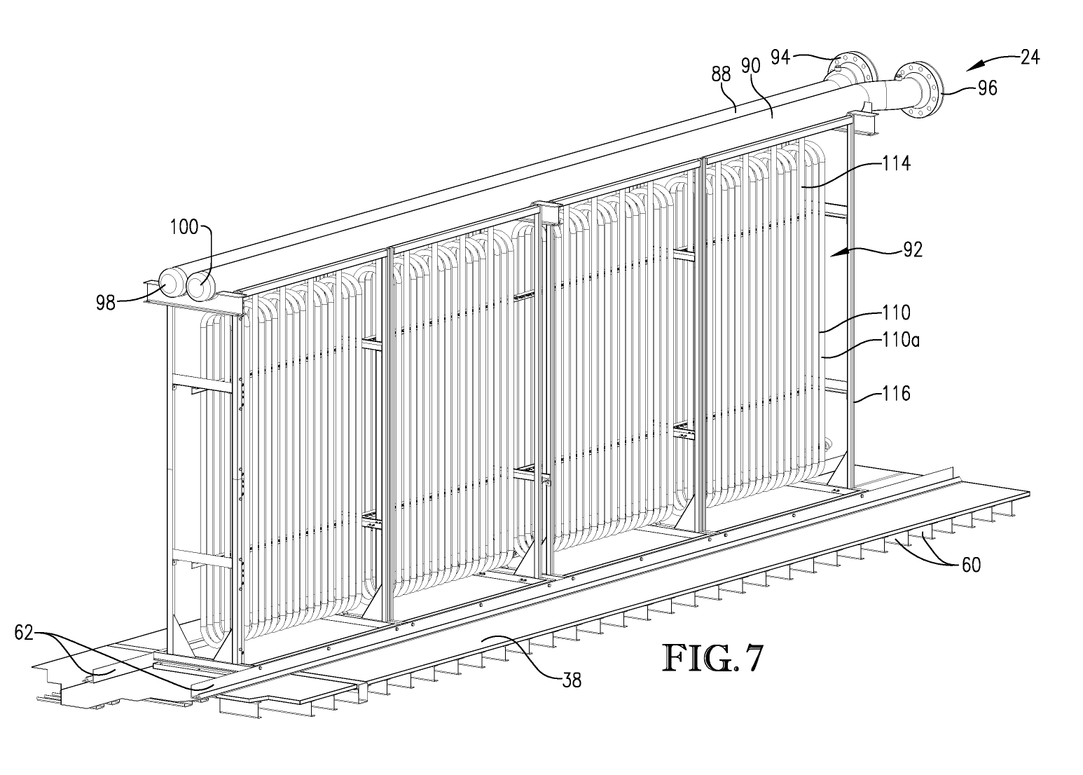

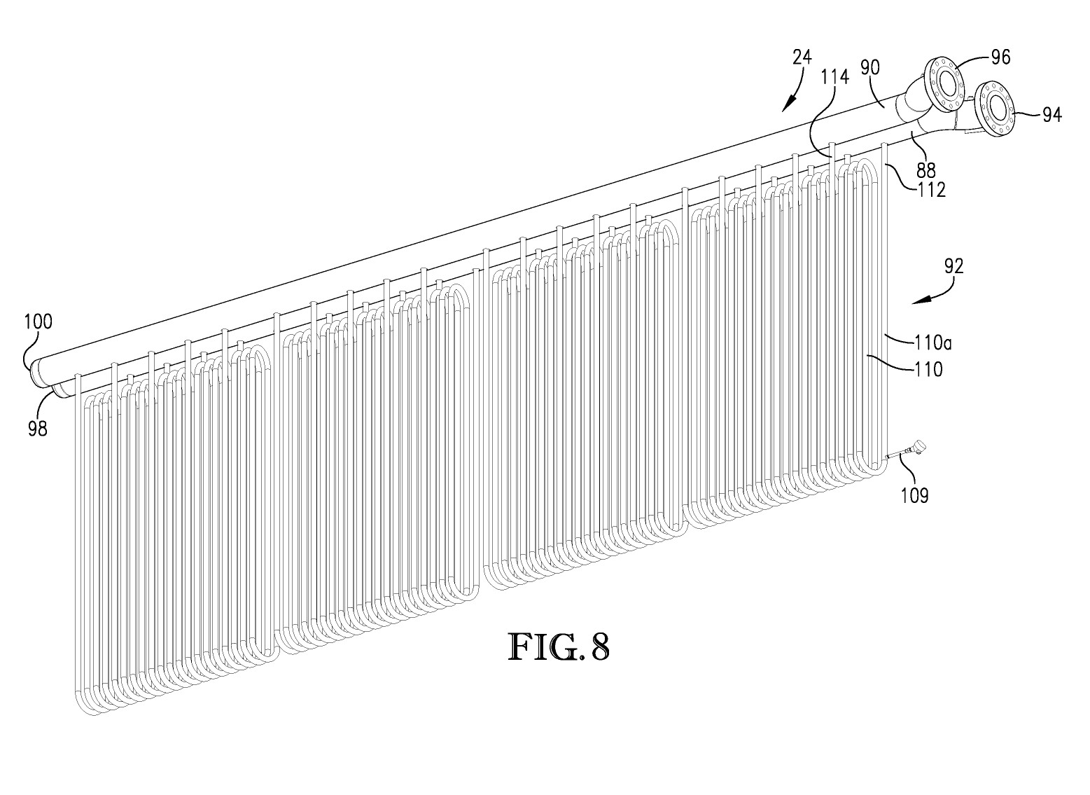

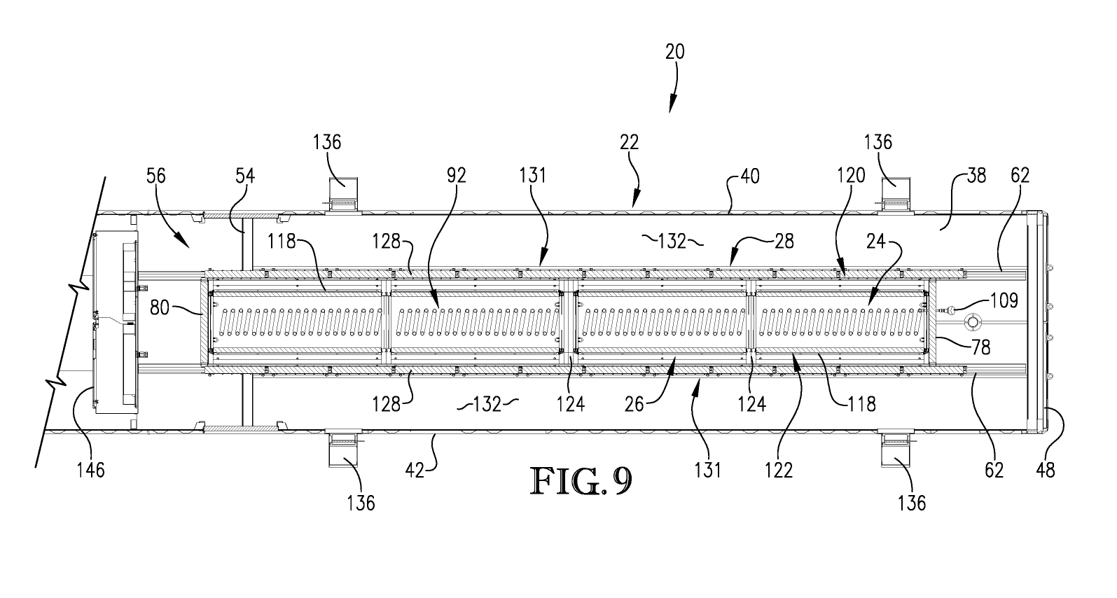

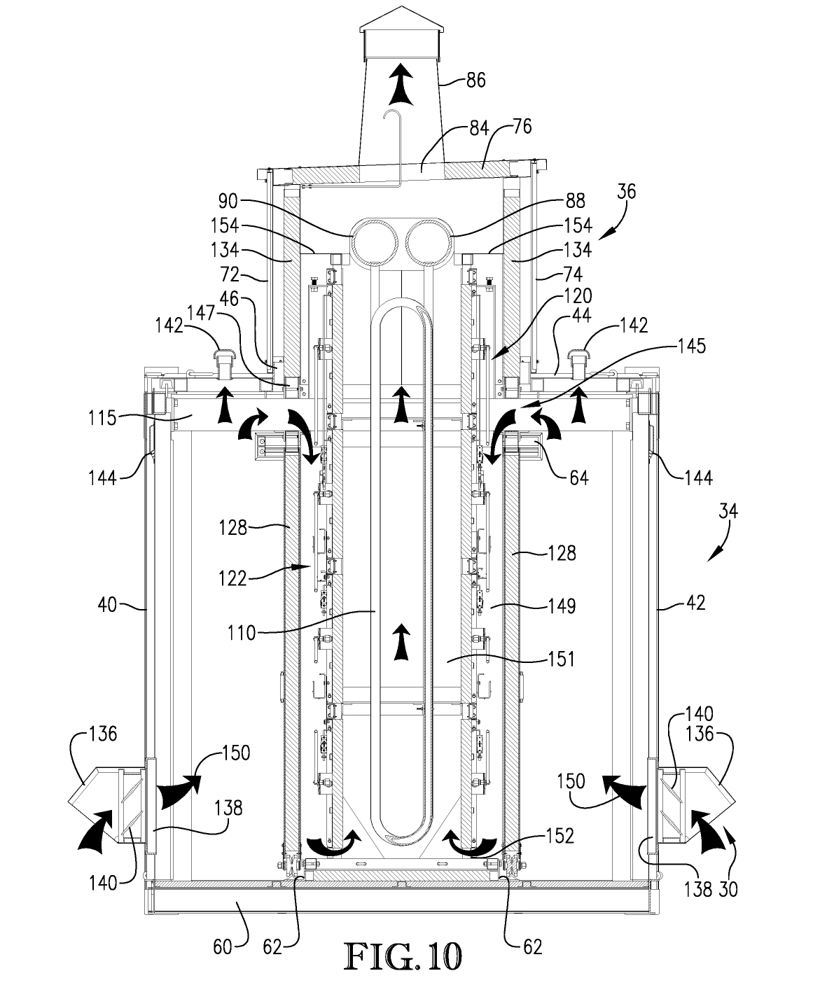

Turning now to the drawings, a self-contained pipeline heater 20 is illustrated in FIG. 1 and broadly includes a housing 22, a fluid-conveying assembly 24 (see also, FIGS. 7-8), an infrared heating assembly 26 (see FIGS. 6 and 9-10), a heat insulating assembly 28 (see FIGS. 4 and 9), an air-cooling assembly 30 (see FIG. 10), and a power and control assembly 32 (see FIG. 6). The purpose of heater 20 is to selectively and efficiently heat an incoming fluid (such as liquid or gaseous petroleum products) at an appropriate location along the length of a pipeline or the like.

The housing 22 generally includes a lower, elongated, substantially rectangular in cross-section primary housing 34 as well as a smaller, upper housing 36 mounted atop the primary housing 34, and defines an enclosed space therein. Although, this configuration presents certain advantages, the scope of the present invention is not limited to this particular design. The overall housing 22 accommodates all of the other assemblies 24-32, as will be described.

The primary housing 34 may be constructed using a standard metal shipping container, but this is not essential. In certain embodiments, the primary housing 34 has bottom wall 38, a pair of laterally spaced apart, upright corrugated sidewalls 40 and 42, as well as a corrugated top wall 44 having an elongated slot 46 formed therein. The forward end of the primary housing 34 has a pair of double doors 48 and, in like manner, the rearward end thereof has a rear wall 50 and a single, central door 52. An intermediate upright wall 54 is provided toward the rearward end of the housing and serves to create a rearmost room 56, which can be accessed via door 52. The walls 40-44 and related structure of the primary housing 34 are supported by conventional frame structure 58. Bottom wall 38 is supported by a series of laterally extending beams 60. A pair of elongated, laterally spaced apart, somewhat L-shaped rails 62 are affixed to the upper surface of wall 38 and extend from the forward end of the housing 34 to intermediate wall 54. Similarly, a pair of elongated tubular beams 64 are secured to the underside of top wall 44 directly above the rails 62 (see FIG. 10). Beams 64 are electrical hazardous location glans and extend through wall 54. The entire heater 20 is typically mounted above-grade on a series of cylindrical concrete footings 66. If desired, front and rear concrete entry pads 68 and 70 are provided adjacent the front and rear doors 48, 52, as illustrated.

The elongated secondary housing 36 is positioned in spanning relationship to the slot 46 of top wall 44 and includes a pair of spaced apart side panels 72 and 74, insulated top panel 76, and insulated front and rear end panels 78 and 80. The front panel 78 has an opening 82 formed therein, whereas top panel 76 has three vent openings 84. An upright, gabled vent housing 86 is secured to top wall 76 in registry with each vent opening 84. It will be appreciated that the secondary housing 36 is smaller in volume as compared with primary housing 34, and has a lesser width, height, and length. Advantageously, the secondary housing 36 is smaller in at least one dimension as compared with the primary housing 34 (e.g., height), and preferably in at least two dimensions (e.g., height and length or length and width). Most preferably, the secondary housing 36 is smaller in all three dimensions of height, length, and width.

The fluid-conveying assembly 24 (see FIGS. 7-8) includes a substantially horizontally oriented fluid inlet conduit or header 88, a juxtaposed fluid outlet conduit or header 90, and a depending coil assembly 92. The headers 88, 90 include connection flanges 94, 96 at the forward ends thereof, and are capped by end caps 98, 100 at their rearward ends. Conventional inlet and outlet pipe assemblies 102, 104 are secured to the headers 88 and 90 by connection to the associated flanges 94, 96. The assemblies 102, 104 are typically capped for transport of the heater 20 to its intended use location by means of caps 106, 108, but in use, fluid entry and exit pipelines (not shown) are operatively connected to the assemblies 102, 104. In this way, the fluid(s) to be heated within heater 20 are conveyed to and from the assembly 24.

The coil assembly 92 is made up of a series of separate, elongated, vertically extending coils 110, each having an inlet pipe 112 coupled with inlet header 88 and a corresponding outlet pipe 114 coupled with outlet header 90. As illustrated, the piping of each coil 110 has a diameter substantially less than the diameter of the associated headers 88, 90, to create a greater surface area for heat transfer. The coils 110 have multiple loops or convolutions 110a which are oblong in configuration and extend vertically beneath the headers 88, 90 as separate passes. The assembly 24 is centrally mounted within housing 22 by means of a plurality of support beam 115 (FIG. 10) that span from sidewall 40 to sidewall 42. Moreover, it will be seen that the headers 88, 90, and the upper ends of the coil assembly 92 are situated within secondary housing 36, whereas the main body of the coil assembly 92 is located within the confines of primary housing 34. The forward ends of the headers 88 and 90 protrude through the opening 82, as illustrated. The coils 110 may have a number of different configurations, such as those described in U.S. Patent Publication No. 2015/0020918, which is incorporated by reference herein in its entirety.

The IR heating assembly 26 includes a plurality of vertically stacked, fore-and-aft extending, gas-fired infrared heating elements 118, which extend the entire length of the coil assembly 92; the elements 118 are operable to emit IR energy through the flameless catalytic combustion of natural gas, and to direct such energy toward coils 110. To this end, the elements 118 are positioned in two separate parallel banks or panels 120 and 122, which are respectively astride the side margins of the coil assembly 92 and extend from a point adjacent bottom wall 38 into the secondary housing 36 to a point just beneath the headers 88, 90 (see FIGS. 9-10). The banks 120, 122 are supported by a supporting frame 116 and upright frame elements 124, and a gas line 125 is provided for delivery of natural gas to the elements 118. The operation of the elements 118 is controlled by appropriate valve and sensor assemblies 126 located adjacent the forward end of housing 22. Exemplary IR heating elements 118 include those available from Catalytic Industrial Group of Independence, Kansas, and are described in U.S. Pat. Nos. 5,557,858 and 6,003,244, both of which are incorporated by reference herein in their entireties. It is also within the scope of the present invention to use electrically powered IR heating elements.

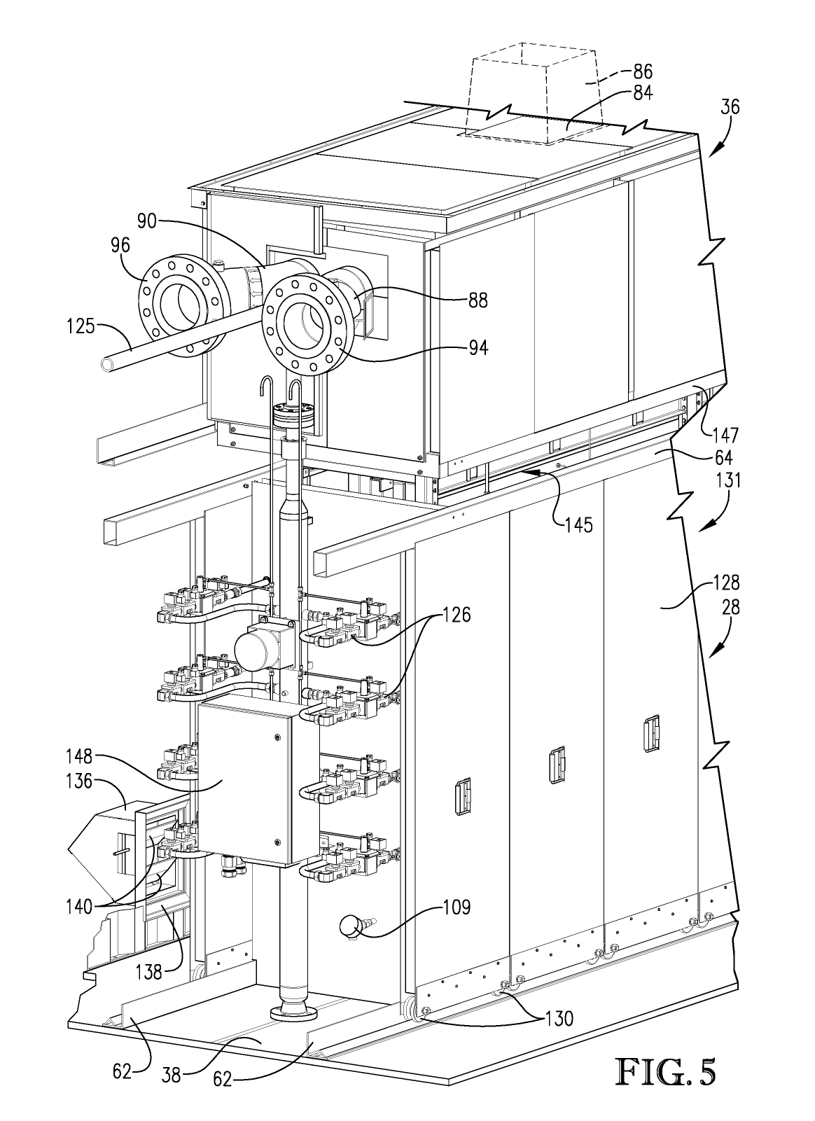

The heat insulating assembly 28 includes a series of upright heat insulating walls 128 positioned within primary housing 34 on opposite sides of the IR heater banks 120, 122. As best illustrated in FIG. 5, walls 128 are mounted on lower grooved rollers 130, whereas the upper ends of the walls are held captive by the rectangular beams 64. Accordingly, the individual walls 128 are simply shifted along the lengths of the rails 62 to create essentially solid insulating walls 131 adjacent the outboard faces of the elements 118 making up the banks 120, 122. As best seen in FIG. 4, the walls 131 extend from a point adjacent the forward end of primary housing 34 to the intermediate wall 54. The spacing between the walls 40, 42 and the adjacent insulating walls 131 provide open passages or walkways 132 extending from the doors 48 to the intermediate wall 54 (FIG. 9); this allows servicing and repair of the internal components of the heater 20.

The overall assembly 28 further includes insulating structure for the secondary housing 36, namely side insulating panels 134 located inboard of the side panels 72, 74, which extend the full length of the secondary housing. The panels 134, together with insulated front and rear panels 78, 80, thus provide the requisite degree of heat insulation for the secondary housing 36.

The air cooling assembly 30 includes a plurality of lower box-like air inlets 136 which are mounted to the sidewalls 40, 42 and communicate with the interior of heater 20 through ports 138 (see FIG. 5). The inlets 136 are equipped with shiftable dampers or louvers 140 to facilitate control of air flow to the heater 20, and thus serve as active air control assemblies. In certain embodiments, inlets 136 serve as the principal air inlet for the space enclosed by housing 22. In addition, the assembly 30 includes a plurality of upright “mushroom” air outlets 142 secured to top wall 44 along the length of secondary housing 36. Additionally, sidewall vents 144 are provided adjacent the upper ends of the sidewalls 40, 42 of primary housing 34.

Power and control assembly 32 includes a conventional electrical entrance panel 146 located within room 56 and adjacent intermediate wall 54. Thus, the panel 146 may be accessed through door 52 as needed. The assembly also has a junction box 148 mounted adjacent the forward end of heater 20 between the valve/sensor assemblies 126. The panel 146 houses the control elements and circuitry for the heater 20, and has one or more programmable digital devices allowing control of the assemblies 24-30 during the operation of heater 20. Box 148 can be readily accessed through forward doors 48. The assembly 32 further has conventional temperature, pressure, and oxygen sensors 143 within the housing 22, and a resistance temperature detector (RTD) 109 coupled with the forward-most coil 110.

In the operation of heater 20, incoming fluid to be heated is conveyed through pipe assembly 102 to header 88 for passage through the coil inlet pipes 112 and ultimately through the individual coils 110. To this end, the incoming fluid is delivered to the heater 20 by means of existing line pressure and the flow rate of which is generally uncontrolled. As the fluid passes through the coils 110, the IR heaters 118 operate to heat the fluid before outward passage thereof from the pipes 114 and header 90. From this point, the now-heated fluid is delivered to the desired use location for heating of the associated pipeline equipment or the like. Also during this heating operation, the air cooling assembly 30 comes into play. That is, operation of the heating elements 118, which can achieve temperatures well above 500F, induces air drafts within housing 22. As best seen in FIG. 10, such induced air currents 150 are drawn through the inlets 136 and pass upwardly for exit through the vents 86, mushroom outlets 142, and side vents 144. At least a portion of the draft is directed through a passage 145 defined between beams 64 and support frame 147 for insulating panels 134 and into a draft-conducting space 149 formed between heater arrays 120, 122 and insulated panels 128. Shields 154 are positioned at the upper ends of space 149 to force the air draft to travel downwardly into space 149. The air moving within space 149 is preheated by heater arrays 120, 122 prior to entering the heat exchange column 151 in which the coils 110 reside. The lower margin of insulated panels 128 is sealed from walkways 132 outboard of panels 128 causing the induced draft to overcome the natural buoyancy of the warming air in space 149 and pass through passageway 152 into the heat exchange column 151. In certain embodiments, the air flowing within column 151 and past coils 110 flows in a direction that is opposite to that of the air flowing in draft-conducting space 149. This air flow can create an environment of convective heat transfer from the fluid flowing through the coils 110 and, if the air flow is too strong, the efficiency of heater 20 is compromised. In order to control the air flow, the louvers 140, operably coupled with control panel 146, are adjusted to maintain the proper air flow through the heater 20. Advantageously, the overall control system for the heater 20 comprises, in addition to the controller panel 146, at least one member selected from the group consisting of an oxygen sensor 143, carbon dioxide sensor, and a pressure transducer installed within the housing 22 and operable to determine a characteristic of the air draft within the housing 22, in order to open or close the louvers 140 based upon determination of such characteristic(s). Hence, the heating/cooling operation of heater 20 may be precisely controlled to achieve optimum performance.

In certain embodiments, it has been found that the pitch of the convolutions 110a of the coils 110 can be adjusted in order to further maximize the efficiency of heater 20. The pitch of these convolutions refers to the lateral spacing between adjacent convolutions. For example, in certain cases, the pitch of the convolutions 110a is selected to keep all of the convolutions maximally “visible” to the opposed banks 120, 122 of the elements 118.

We claim:

1. A pipeline heater comprising:
a housing comprising a plurality of wall sections defining an enclosed space, at least one of said wall sections comprising at least one selectively controllable air flow damper installed therein to control the flow of air into said enclosed space, at least one other of said wall sections comprising a vent opening through which air and exhaust gases flow out of said enclosed space;
at least two conduit sections located within said housing, one of said conduit sections configured to conduct a fluid stream into said housing and one other of said to conduit sections configured to conduct said fluid stream out of said housing;
at least one coil disposed within said housing having a coil inlet and a coil outlet, said coil inlet being fluidly coupled with said conduit section configured to conduct said fluid stream into said housing, said coil outlet being fluidly coupled with said conduit section configured to conduct said fluid stream out of said housing; and
a plurality of infrared catalytic heaters located adjacent to said at least one coil and configured to warm said fluid stream flowing within said coil.

2. The pipeline heater according to claim 1, wherein said pipeline heater comprises a control system operable to control said at least one air flow damper, said control system comprising at least one member selected from the group consisting of an oxygen sensor, a pressure transducer, and a carbon dioxide sensor installed within said housing and operable to determine a characteristic of an air draft flowing within said enclosed space and between said at least one air flow damper and said vent opening and open or close said air flow dampers based upon determination of said characteristic.

3. The pipeline heater according to claim 1, wherein said at least one air flow damper comprises the principal air inlet into said enclosed space.

4. The pipeline heater according to claim 1, wherein said coil comprises a plurality of substantially vertical, elongate passes.

5. The pipeline heater according to claim 1, wherein said plurality of catalytic heaters are arranged into at least a first and a second bank of heaters, said first bank of heaters being located on an opposite side of said at least one coil than said second bank of heaters.

6. The pipeline heater according to claim 5, wherein said pipeline heater comprises a respective insulating wall disposed outboard of each of said banks of heaters, said respective insulating wall and said bank of heaters defining therebetween a draft-conducting space.

7. The pipeline heater according to claim 6, wherein said draft-conducting space is configured to direct an air draft flowing within said housing between said at least one air flow damper and said vent opening in a direction that is opposite to the direction in which said air draft flows across said at least one coil.

8. The pipeline heater according to claim 1, wherein said heater comprises a plurality of coils installed within said housing in a parallel fluid flow configuration.

9. A pipeline heater comprising:
a housing including an upper housing portion and a lower housing portion;
at least two conduit sections located within said upper housing portion, one of said conduit sections configured to conduct a fluid stream into said housing and one other of said conduit sections configured to conduct said fluid stream out of said housing;
at least one coil disposed within said housing having a coil inlet and a coil outlet, said coil inlet being fluidly coupled with said conduit section configured to conduct said fluid stream into said housing, said coil outlet being fluidly coupled with said conduit section configured to conduct said fluid stream out of said housing; and
a plurality of infrared catalytic heaters located adjacent to said at least one coil and configured to warm said fluid stream flowing within said coil.

10. The pipeline heater according to claim 9, wherein said lower housing portion has a greater volume than the upper housing portion.

11. The pipeline heater according claim 10, wherein said upper housing portion is smaller in at least one dimension than said lower housing portion.

12. The pipeline heater according to claim 9, wherein said upper housing portion comprises at least one vent communicating the interior of said housing with the exterior of said housing.

13. The pipeline heater according to claim 9, wherein said conduit sections are oriented substantially parallel to each other within said upper housing portion.

14. The pipeline heater according to claim 9, wherein said conduit sections are oriented substantially horizontally within said upper housing portion.

15. The pipeline heater according to claim 9, wherein said coil is of smaller diameter than both of said at least two conduit sections.

16. The pipeline heater according to claim 9, wherein said coil inlet extends substantially perpendicularly from said conduit section configured to conduct a fluid stream into said housing.

17. The pipeline heater according claim 9, wherein said coil outlet extends substantially perpendicularly toward said conduit section configured to conduct a fluid stream out of said housing.

18. The pipeline heater according to claim 9, wherein at least a portion of said coil is located within said lower housing portion, and at least a portion of said coil is located in said upper housing portion.

19. The pipeline heater according to claim 9, wherein said housing comprises one or more active air control assemblies installed within ports formed in one or more sidewalls of said housing, said active air control assemblies comprising adjustable air flow dampers operable to control an air draft within said housing.

20. The pipeline heater according to claim 19, wherein said pipeline heater comprises a control system operable to control said air flow dampers, said control system comprising at least one member selected from the group consisting of an oxygen sensor, a pressure transducer, and a carbon dioxide sensor installed within said housing and operable to determine a characteristic of said air draft within said housing and open or close said air flow dampers based upon determination of said characteristic.

21. The pipeline heater according to claim 9, said housing comprising a primary housing and a secondary housing positioned atop the primary housing, the interiors of the primary and secondary housings being in communication with each other.

22. A method of warming a fluid stream comprising the steps of:
directing a fluid into a pipeline heater in accordance with claim 1 by passing said fluid into one of said conduit sections and causing said fluid to enter said at least one coil;
operating said plurality of heaters so as to direct heat energy to said at least one coil for transfer to said fluid to form a warmed fluid; and
removing said warmed fluid from said pipeline heater via one other of said conduit sections.

23. The method of claim 22, including the step of controlling the flow of air drafts through said housing during the operation of said heaters by selectively opening or closing said at least one air flow damper.

24. A method of warming a fluid stream comprising the steps of:
directing a fluid into a pipeline heater in accordance with claim 1 by passing said fluid into one of said conduit sections and causing said fluid to enter said at least one coil;
operating said plurality of heaters so as to direct heat energy to said at least one coil for transfer to said fluid to form a warmed fluid; and
removing said warmed fluid from said pipeline heater via one other of said conduit sections.
